(19) United States
(12) Patent Application Publication
(10) Pub. No.: US 2018/0285294 A1
(43) Pub. Date: Oct. 4, 2018

(54) QUALITY OF SERVICE BASED HANDLING OF INPUT/OUTPUT REQUESTS METHOD AND APPARATUS

(71) Applicant: ANJANEYA R. CHAGAM REDDY, CHANDLER, AZ (US)

(72) Inventor: ANJANEYA R. CHAGAM REDDY, CHANDLER, AZ (US)

(21) Appl. No.: 15/477,067

(22) Filed: Apr. 1, 2017

(51) Int. Cl. G06F 13/30; G06F 13/37; G06F 13/18; G06F 9/50; G06F 9/48; H04L 12/851; H04L 12/861

(52) U.S. Cl. CPC G06F 13/30; G06F 13/37; G06F 13/18; G06F 2209/5021; G06F 9/4881; H04L 47/2441; H04L 49/90; G06F 9/5016

(57) ABSTRACT

Apparatus and method to perform quality of service based handling of input/output (IO) requests are disclosed herein. In embodiments, one or more processors include a module that is to allocate an input/output (IO) request command, associated with an IO request originated within a compute node, to a particular first queue of a plurality of first queues based at in part on IO request type information included in the IO request command, the compute node and the apparatus distributed over a network and the plurality of first queues associated with different submission handling priority levels among each other, and wherein the module allocates the IO request command queued within the particular first queue to a particular second queue of a plurality of second queues based at least in part on affinity of a first submission handling priority level associated with the particular first queue to current quality of service (QoS) attributes of a subset of the one or more storage devices associated with the particular second queue.

### FIELD OF THE INVENTION

The present disclosure relates generally to the technical fields of computing networks and storage, and more particularly, to improving servicing of input/output requests by storage devices.

### BACKGROUND

The background description provided herein is for the purpose of generally presenting the context of the disclosure. Unless otherwise indicated herein, the materials described in this section are not prior art to the claims in this application and are not admitted to be prior art or suggestions of the prior art, by inclusion in this section.

A data center network may include a plurality of nodes which may generate, use, modify, and/or delete a large number of data content (e.g., files, documents, pages, data packets, etc.). The plurality of nodes may include a plurality of compute nodes, which may perform processing functions such as run applications, and a plurality of storage nodes, which may store data used by the applications. In some embodiments, one or more of the plurality of storage nodes may be associated with additional storage also included in the data center network, such as storage devices (for example, solid state drives (SSDs), hard disk drives (HDDs), hybrid drives). At a given time, a large number of data-related requests, such as from one or more compute nodes of the plurality of compute nodes, may be received by and/or outstanding at a particular associated storage device. Handling the large number of data-related requests by the particular associated storage devices while maintaining desired performance, latency, and/or other metrics may be difficult.

### BRIEF DESCRIPTION OF THE DRAWINGS

Embodiments will be readily understood by the following detailed description in conjunction with the accompanying drawings. The concepts described herein are illustrated by way of example and not by way of limitation in the accompanying figures. For simplicity and clarity of illustration, elements illustrated in the figures are not necessarily drawn to scale. Where considered appropriate, like reference labels designate corresponding or analogous elements.

FIG. 1 depicts a block diagram illustrating a network view of an example system incorporated with a quality of service based mechanism of the present disclosure, according to some embodiments.

FIG. 2 depicts an example diagram illustrating a rack-centric view of at least a portion of the system of FIG. 1, according to some embodiments.

FIG. 3 depicts an example block diagram illustrating a logical view of a rack scale module, the block diagram illustrating hardware, firmware, and/or algorithmic structures and data associated with the processes performed by such structures, according to some embodiments.

FIG. 4 depicts an example process that may be performed by the rack scale module to generate volume groups for different performance attributes, according to some embodiments.

FIG. 5 depicts an example process that may be performed by a DSS module and a QoS module to fulfill an IO request initiated by a compute node including the DSS module, according to some embodiments.

FIG. 6 depicts an example diagram illustrating depictions of submission command capsules and queues which may be implemented to provide dynamic end to end QoS enforcement of the present disclosure, in some embodiments.

FIG. 7 illustrates an example computer device suitable for use to practice aspects of the present disclosure, according to some embodiments.

FIG. 8 illustrates an example non-transitory computer-readable storage media having instructions configured to practice all or selected ones of the operations associated with the processes described herein, according to some embodiments.

### DETAILED DESCRIPTION

Embodiments of apparatuses and methods related to quality of service based handling of input/output requests are described. In some embodiments, an apparatus may include one or more storage devices; and one or more processors including a plurality of processor cores in communication with the one or more storage devices, wherein the one or more processors include a module that is to allocate an input/output (IO) request command, associated with an IO request originated within a compute node, to a particular first queue of a plurality of first queues based at in part on IO request type information included in the IO request command, the compute node and the apparatus distributed over a network and the plurality of first queues associated with different submission handling priority levels among each other, and wherein the module allocates the IO request command queued within the particular first queue to a particular second queue of a plurality of second queues based at least in part on affinity of a first submission handling priority level associated with the particular first queue to current quality of service (QoS) attributes of a subset of the one or more storage devices associated with the particular second queue. These and other aspects of the present disclosure will be more fully described below.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. Additionally, it should be appreciated that items included in a list in the form of “at least one A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). As used herein, the term “logic” and “module” may refer to, be part of, or include an application specific integrated circuit (ASIC), an electronic circuit, a programmable combinatorial circuit (such as programmable gate arrays (FPGA)), a processor (shared, dedicated, or group), and/or memory (shared, dedicated, or group) that execute one or more software or firmware programs having machine instructions (generated from an assembler and/or a compiler), and/or other suitable components that provide the described functionality.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

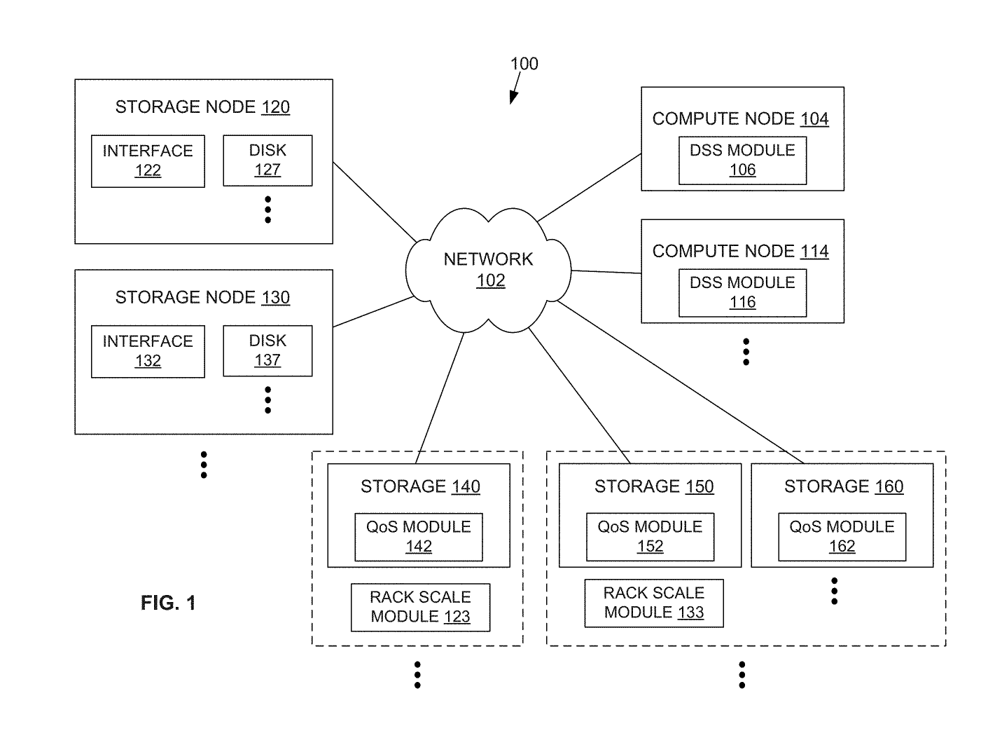

FIG. 1 depicts a block diagram illustrating a network view of an example system 100 incorporated with a quality of service based mechanism of the present disclosure, according to some embodiments. System 100 may comprise a computing network, a data center, a computing fabric, a storage fabric, a compute and storage fabric, and the like. In some embodiments, system 100 may include a network 102; a plurality of compute nodes 104, 114; a plurality of storage nodes 120, 130; and a plurality of storage 140, 150, 160. Network 102 may be coupled to and in communication with the plurality of compute nodes 104, 114 and the plurality of storage nodes 120, 130 (which may collectively be referred to as nodes) as well as the plurality of storage 140, 150, 160.

In some embodiments, network 102 may comprise one or more switches, routers, firewalls, gateways, relays, repeaters, interconnects, network management controllers, servers, memory, processors, and/or other components configured to interconnect and/or facilitate interconnection of nodes 104, 114, 120, 130 storage 140, 150, 160 to each other. The network 102 may also be referred to as a fabric, compute fabric, or cloud.

Each compute node of the plurality of compute nodes 104, 114 may include one or more compute components such as, but not limited to, servers, processors, memory, processing servers, memory servers, multi-core processors, multi-core servers, and/or the like configured to provide at least one particular process or network service. A compute node may comprise a physical compute node, in which its compute components may be located proximate to each other (e.g., located in the same rack, same drawer or tray of a rack, adjacent racks, adjacent drawers or trays of rack(s), same data center, etc.) or a logical compute node, in which its compute components may be distributed geographically from each other such as in cloud computing environments (e.g., located at different data centers, distal racks from each other, etc.). More or less than two compute nodes may be included in system 100. For example, system 100 may include hundreds or thousands of compute nodes.

In some embodiments, each of compute nodes 104, 114 may be configured to run one or more applications, in which an application may execute on a variety of different operating system environments such as, but not limited to, virtual machines (VMs), containers, and/or bare metal environments. Alternatively or in addition to, compute nodes 104, 114 may be configured to perform one or more functions that may be associated with input/output (IO) requests or needs. Applications or functionalities performed on a compute node may have IO requests or needs that involve storage external to the compute node. An IO request may comprise a read request initiated by an application executing on the compute node, a write request initiated by an application executing on the compute node, a foreground operation to be performed, a background operation to be performed (e.g., background scrubbing, drive rebuild, de-duping, etc.), and the like to be fulfilled by storage external to a compute node (e.g., storage 1140, 150, or 160).

To handle at least some IO requests involving remote storage, and in particular, storage 140, 150, 160, each compute node of the plurality of compute nodes 104, 114 may include a distributed storage service (DSS) module. Compute node 104 may include a DSS module 106 and the compute node 114 may include a DSS module 116. In response to an IO request within the compute node 104, DSS module 106 may be configured to generate an IO request command to a particular storage node (e.g., storage node 120 or 130) that includes information about the type of the IO request (e.g., whether the IO request comprises a foreground or background operation) and other possible characteristic information about the IO request. As described in detail below, characteristic information about the IO request in the IO request command may be of a format and substance which may be used by a particular storage of the plurality of storage 140, 150, 160 to implement the quality of service based mechanism. DSS module 116 may be similarly configured with respect to IO requests within the compute node 114. DSS modules 106, 116 may also be referred to as initiator DSS modules, host DSS modules, initiator modules, compute node side DSS modules, and the like.

Each storage node of the plurality of storage nodes 120, 130 may include one or more storage components such as, but not limited to, interfaces, disks, storage, hard drive disks (HDDs), flash based storage, storage processors or servers, and/or the like configured to provide data read and write operations/services for the system 100. A storage node may comprise a physical storage node, in which its storage components may be located proximate to each other (e.g., located in the same rack, same drawer or tray of a rack, adjacent racks, adjacent drawers or trays of rack(s), same data center, etc.) or a logical storage node, in which its storage components may be distributed geographically from each other such as in cloud computing environments (e.g., located at different data centers, distal racks from each other, etc.). Storage node 120 may, for example, include an interface 122 and one or more disks 127; and storage node 130 may include an interface 132 and one or more disks 137. More or less than two storage nodes may be included in system 100. For example, system 100 may include hundreds or thousands of storage nodes.

A storage node may also be associated with one or more additional storage, which may be remotely located from the storage node and/or provisioned separately to facilitate additional flexibility in storage capabilities. In some embodiments, such additional storage may comprise the storage 140, 150, 160. Storage 140, 150, 160 may comprise solid state drives (SSDs), non-volatile memory (NVM), non-volatile dual in-line memory (DIMM), flash-based storage, or hybrid drives, storage having faster access speed than disks included in the storage nodes 120, 130, and/or storage which communicates with host(s) over a non-volatile memory express-over fabric (NVMe-oF) protocol (also referred to as NVMe-oF targets or targets). Details regarding the NVMe-oF protocol may be provided in <<www.nvmexpress.org/wp-content/uploads/NVMe_over_Fabrics_1_0_Gold_20160605.pdf>>. Storage 140, 150, 160 may comprise examples of such additional storage.

The additional storage may be associated with one or more storage nodes. A portion of an additional storage may be associated with one or more storage nodes. In other words, an additional storage and a storage node may have a one to many and/or many to one association. For example, an additional storage may be partitioned into five sections, with a first partition being associated with a first storage node, second and third partitions being associated with a second storage node, a part of a fourth partition being associated with a third storage node, and another part of the fourth partition and a fifth partition being associated with a fourth storage node. As another example, storage node 120 may be associated with one or more storage 140, 150, 160; and storage node 140 may be associated with one or more storage 140, 150, 160.

In some embodiments, each of the storage nodes of the plurality of storage nodes 120, 130 may further include an interface configured to provide processing functionalities associated with reads, writes, and/or maintenance of data in the disks of the storage node and/or to perform intermediating functionalities to forward IO requests from compute nodes to particular ones of its associated storage 140, 150, 160. The interface may also be referred to as a storage processor or server. As shown in FIG. 1, interfaces 122, 132 may be respectively included in storage nodes 120, 130. In some embodiments, interfaces 122, 132 may communicate with respective associated storage 140, 150, 160 over a network fabric, such as network 102.

Storage 140, 150, 160 may include one or more compute components and/or storage components. Each storage 140, 150, 160 may include a quality of service (QoS) module configured to dynamically manage IO requests from compute nodes having a variety of workload or QoS requirements, as described in detail below. Storage 140, 150, 160 may include respective QoS modules 142, 152, 162. Each storage 140, 150, 160 may include one or more storage processors or interfaces (e.g., compute components) to implement its QoS module and to perform other functionalities associated with fulfillment of IO requests. The one or more storage processors or interfaces may comprise single or multi-core processors or interfaces. Each storage 140, 150, 160 may also include one or more storage devices or drives (e.g., storage components). In some embodiments, particular cores of the storage processors/interfaces may be mapped to particular one or more storage devices/drives (or particular one or more partitions of the storage devices/drives) for each storage 140, 150, 160. For example, storage 140 may include twenty storage devices/drives (storage devices/drives 1-20) and its processors/interfaces have five cores (cores 1-5). Core 1 may be mapped to storage devices/drives 1-5, core 2 maybe mapped to storage devices/drives 6-8, core 3 may be mapped to storage devices/drives 9-15, core 4 may be mapped to certain partitions of storage devices/drives 16-18, and core 5 may be mapped to remaining partitions of storage devices/drives 16-18 and storage devices/drives 19-20. Fewer or more than three storage may be included in system 100.

In some embodiments, storage nodes 120, 130 may serve as intermediating components/devices between compute nodes 104, 114 and storage 140, 150, 160. For example, an IO request command initiated in compute node 104 may be transmitted to storage node 120 via network 102. Storage node 120, in turn, may perform intermediating functionalities to issue an IO request command corresponding to the initial/original IO request command to storage 140 via network 102. Upon receipt of the IO request command from storage node 120, the storage 140, and in particular, QoS module 142, may dynamically service the IO request while achieving performance requirements for this IO request as well as other IO requests being handled at the storage 140.

In some embodiments, a rack scale module may be associated with one or more of storage 140, 150, 160. As an example, FIG. 1 shows that a rack scale module 123 may be associated with storage 140, and a rack scale module 133 may be associated with storage 150, 160. In some embodiments, a rack scale module may be included in the same rack that houses a storage. As described in detail below, the rack scale modules 123, 133 may be included in components provisioned on a rack level. Accordingly, depending on which racks of components together may be considered to comprise a storage 140, 150, or 160 and/or the extent of redundancy associated with the rack scale modules, the number and existence of the rack scale modules for a storage may vary.

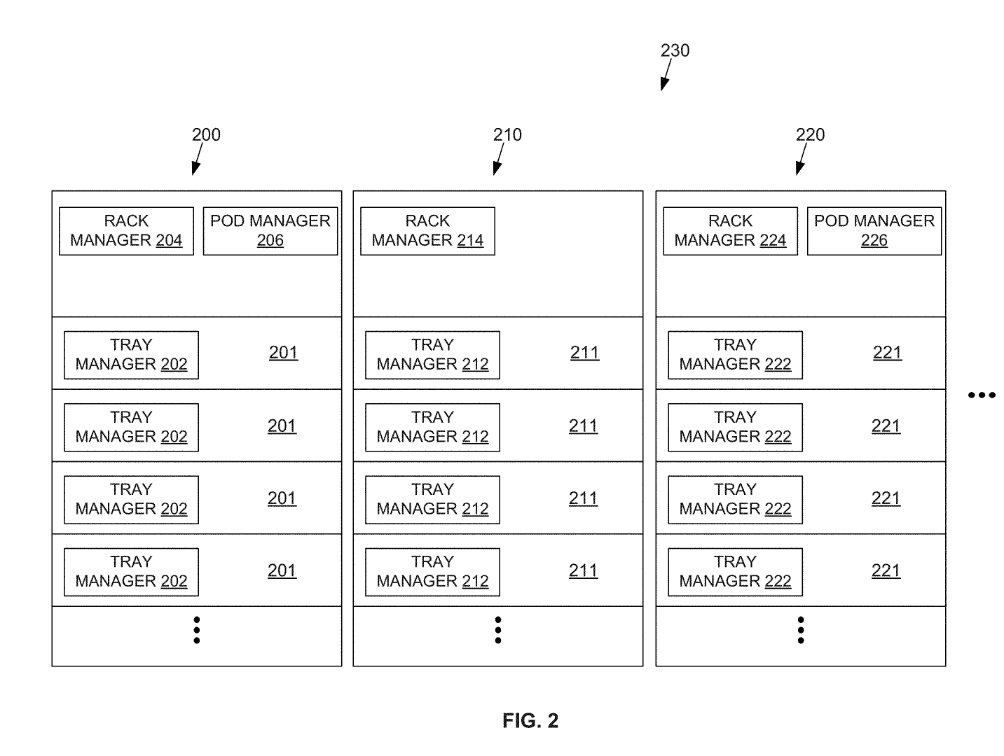

FIG. 2 depicts an example diagram illustrating a rack-centric view of at least a portion of the system 100, according to some embodiments. A collection or pool of racks 230 (also referred to as a pod of racks, rack pod, or pod) may comprise a plurality of racks 200, 210, 220, in which the collection of racks 230 may comprise, for example, approximately fifteen to twenty-five racks. The collection of racks 230 may comprise racks associated with one or more storage nodes, storage (e.g., NVMe-oF targets), compute nodes, and/or other logical grouping of components in the system 100. A rack of the plurality of racks 200, 210, 220 may comprise a physical structure or cabinet located in a data center, configured to hold a plurality of compute and/or storage components in respective plurality of component drawers or trays. For example, racks 200, 210, 220 may include respective plurality of component drawers or trays 201, 211, 221.

In order to facilitate operation of the compute and/or storage components inserted in a rack (which may be referred to as client components from a rack's point of view), each rack may also include “utility” components (e.g., power connections, network connections, thermal or cooling management, thermal sensors, etc.) and rack management components (e.g., hardware, firmware, circuitry, sensors, processors, detectors, management network infrastructure, and the like). In some embodiments of the present disclosure, rack management components of a rack may be configured to automatically discover, detect, obtain, analyze, maintain, test, and/or otherwise manage a variety of hardware state information associated with each hardware component (e.g., NVMe-oF targets, servers, memory, processors, interfaces, disks, etc.) inserted into (or pulled from) any of the rack's component drawers or trays. Alternatively, the rack management components may manage hardware state information associated with at least drives of the storage 140, 150, 160 (e.g., NVMe-oF targets) inserted into (or pulled from) the rack's component drawers or trays.

For example, when a drive may be inserted into a particular component tray/drawer of a particular rack, the particular component tray/drawer may include hardware or firmware (e.g., sensors, detectors, circuitry) configured to detect insertion of the drive and other information about the drive. Such hardware/firmware, in turn, may communicate via the rack management network infrastructure to a component that may collect such information from a plurality of the component trays/drawers and/or a plurality of the racks (e.g., the racks comprising a pod). In some embodiments, hardware state management (and associated functions) may be performed using a plurality of building blocks or components—tray managers, rack managers, and pod managers, collectively referred to as a rack scale module (e.g., rack scale module 123), as described in detail below. In some embodiments, a tray manager may be associated with each component tray/drawer so as to facilitate hardware state management functionalities at the particular tray/drawer level; a rack manager may be associated with each rack so as to facilitate hardware state management functionalities at the particular rack level; and a pod manager may be associated with a particular pod of racks so as to facilitate hardware state management functionalities at the particular pod level. A lower level manager may “report” up to a next higher level manager so that the highest level manager (e.g., the pod manager) may ultimately possess a complete set of information about the hardware components of its pod of racks. The pod manager may accordingly be in possession of the current state of each piece of hardware within its pod of racks.

As an example, rack 200 shown in FIG. 2 may include a plurality of tray managers 202 for respective plurality of component trays/drawers 201, a rack manager 204, and a pod manager 206; rack 210 may include a plurality of tray managers 212 for respective plurality of component trays/drawers 211 and a rack manager 214; and rack 220 may include a plurality of tray managers 222 for respective plurality of component trays/drawers 221, a rack manager 224, and a pod manager 226. In some embodiments, single or multiple instances of a pod manager for the collection/pod of racks 230 may be implemented. For example, pod manager 206 may be considered the primary pod manager for the collection/pod of racks 230 and pod manager 226 may be considered a secondary pod manager to pod manager 206 (e.g., for redundancy purposes). Alternatively, pod managers 206 and 226 may collectively comprise the pod manager for the collection/pod of racks 230. As another alternative, pod manager 226 may be omitted. In yet another alternative, more than two pod managers may be distributed within the collection/pod of racks 230.

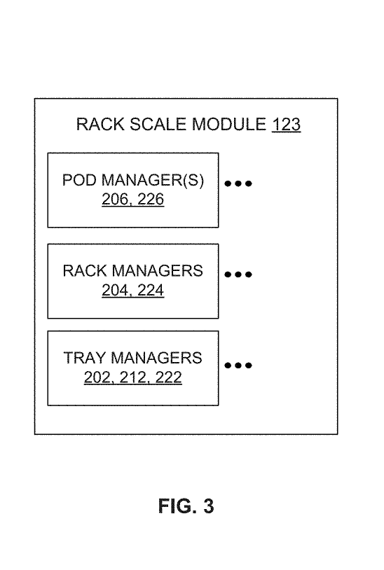

FIG. 3 depicts an example block diagram illustrating a logical view of the rack scale module 123, the block diagram illustrating hardware, firmware, and/or algorithmic structures and data associated with the processes performed by such structures, according to some embodiments. The following description of rack scale module 123 may similarly apply to rack scale module 133. FIG. 3 illustrates example modules and data that may be included in, used by, and/or associated with rack 200 (or rack processor associated with rack 200), rack 210 (or rack processor associated with rack 210), rack 220 (or rack processor associated with rack 220), compute node 104, compute node 114, storage node 120, storage node 130, storage 140, storage 150, storage 160, and/or the like, according to some embodiments.

In some embodiments, rack scale module 123 may include tray managers 202, 212, 222, rack managers 204, 224, and pod manager(s) 206 and/or 226. Rack scale module 123 may also be referred to as rack scale design (RSD). In some embodiments, the tray managers may comprise the lowest or smaller building block. Each of the tray managers 202, 212, 222 may be configured to automatically discover, detect, or obtain characteristics of hardware components within its tray/drawer (e.g., obtain hardware state information at a tray level). Examples of discovered hardware characteristics may include, without limitation, one or more performance characteristics (e.g., time to perform read and write operations) of drives included in storage 140. Each of the tray managers 202, 212, 222 may be implemented as firmware, such as one or more chipsets running software or logic. Alternatively, one or more of the tray managers 202, 212, 22 may comprise hardware (e.g., sensors, detectors) and/or software.

The next higher building block from tray managers may comprise the rack managers. Each of the rack managers 204, 224 may be configured to automatically discover, detect, or obtain detect characteristics of the rack (e.g., obtain hardware state information at a rack level). In some embodiments, at least some of the hardware state information at the rack level for a given rack may be provided by the tray managers included in the given rack. Each of the rack managers 204, 224 may be implemented as firmware, such as one or more chipsets running software or logic. Alternatively, one or more of the rack managers 204, 224 may comprise hardware (e.g., sensors, detectors) and/or software.

The next higher building block from rack managers may comprise the pod manager(s). Each of the pod manager(s) 206 and/or 226 may be configured to collate, analyze, or otherwise use the hardware state information at the rack and tray levels for its associated trays and racks to generate hardware state information at the pod level for the hardware components included in the pod. Pod manager(s) 206, 226 may use information provided by client entities subscribing to or being hosted by the system 100 (e.g., also referred to as tenants, data center subscribers, and the like) along with the hardware state information at the pod level to create a plurality of volume groups associated with respective plurality of particular performance characteristics/attributes for the drives of storage included in the pod. In some embodiments, the pod managers 206, 226 may be implemented as software comprising one or more instructions to be executed by one or more processors included in processors, servers, or the like within the storage or rack(s) designated to be within the pod associated with the pod managers 206, 226. Alternatively, one or more of the pod managers 206, 226 may be implemented as hardware and/or software.

In some embodiments, the pod associated with pod managers 206, 226 may comprise a collection of storage 140,150, 160; the drives of one or more of the storage 140, 150,160; fewer than all drives of a storage of the storage 140, 150, 160; and the like. In some embodiments, tray managers 202, 212, 222, rack managers 204, 224, and pod manager(s) 206 and/or 226 may communicate with each other using a rack management network or other communication mechanisms (e.g., a wireless network), which may be the same or different from network 102. When, for instance, rack scale module 123 may be associated with drives of the storage 140, volume groups created and classification of drives of the storage 140 into the volume groups may be provided from the rack scale module 123 to the storage 140 (e.g., to QoS module 142 included in the storage 140).

In some embodiments, one or more of the tray managers 202, 212, 222, rack managers 204, 224, pod managers 206, 226, rack scale modules 123, 133, DSS modules 106, 116, and QoS modules 142, 152, 162 may be implemented as software comprising one or more instructions to be executed by one or more processors or servers included in the system 100. In some embodiments, the one or more instructions may be stored and/or executed in a trusted execution environment (TEE) of the one or more processors or servers. Alternatively, one or more of the tray managers 202, 212, 222, rack managers 204, 224, pod managers 206, 226, rack scale modules 123, 133, DSS modules 106, 116, and QoS modules 142, 152, 162 may be implemented as firmware or hardware such as, but not limited to, an application specific integrated circuit (ASIC), programmable array logic (PAL), field programmable gate array (FPGA), circuitry, on-chip circuitry, on-chip memory, and the like.

Although tray managers 202, 212, 222, rack managers 204, 224, pod managers 206, 226, rack scale modules 123, 133, DSS modules 106, 116, and QoS modules 142, 152, 162 may be depicted as distinct components, one or more of tray managers 202, 212, 222, rack managers 204, 224, pod managers 206, 226, rack scale modules 123, 133, DSS modules 106, 116, and QoS modules 142, 152, 162 may be implemented as fewer or more components than illustrated.

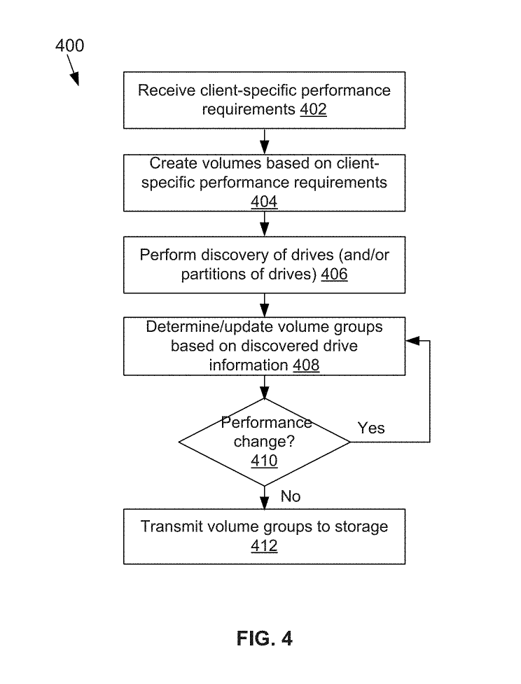

FIG. 4 depicts an example process 400 that may be performed by rack scale module 123 to generate volume groups for different performance attributes, according to some embodiments. Process 400 is described with respect to generating volume groups associated with storage devices/drives of storage 140. Process 400 may similarly be implemented to generate volume groups associated with storage 150, 160.

At a block 402, pod manager(s) included in rack scale module 123 may be configured to receive client-specific performance requirements from a plurality of clients of the system 100. Clients may comprise client entities that subscribe to one or more services provided the system 100, such as the system 100 hosting client's website, system 100 handling client's online payment functions, system 100 providing cloud services for the client, system 100 providing data center functionalities for the client, and the like. Clients may also be referred to as client entities, tenants, users, subscribers, data center tenants, data center subscribers, and the like. In some embodiments, system 100 may provide a portal or user interface for clients to subscribe to one or more services provided by the system 100 and specify one or more performance requirements. For example, a client may use the portal to open an account, specify desired storage capacity, geographic regions in which storage may be required, security level, one or more client-specific performance requirements, and the like.

In some embodiments, one or more client-specific performance requirements may comprise one or more QoS or latency requirements for client initiated or associated IO requests to be made to storage. For example, the one or more client-specific performance requirements may comprise a latency of less than 100 microseconds for all client initiated IO requests, which may require that each of this particular client's IO requests is to be completed within 100 microseconds or less. As another example, the one or more client-specific performance requirements may comprise a latency of less than 300 microseconds for client initiated IO requests originating from the client's North American customers and a latency of less than 100 microseconds for clients initiated IO requests originating from the client's Asian customers. Client-specific performance requirements may also be referred to as client assisted QoS.

Next at a block 404, pod manager(s) included in rack scale module 123 may be configured to create, generate, or define volumes based on the client-specific performance requirements received at block 402. In some embodiments, volumes may be considered to be buckets, in which each volume or bucket may be associated with a particular performance attribute or characteristic. Each particular performance attribute/characteristic may comprise a particular performance band or range of the client-specific performance requirements of the plurality of clients. For instance, three volumes may be defined, in which volume 1 may be associated with a high performance band/range (e.g., latencies below 1 microsecond), volume 2 may be associated with a medium performance band/range (e.g., latencies between 1 microseconds to 200 microseconds), and volume 3 may be associated with a low performance band/range (e.g., latencies greater than 200 microseconds).

At a block 406, tray managers included in the rack scale module 123 may be configured to perform discovery of drives (or partitions of drives) of the storage 140. A variety of real-time, near real-time, or current information about a drive and the state of the drive, as well as other associated hardware-related information may be obtained (e.g., via automatic detection, interrogation of drives, drive registration mechanism, contribution of third party information, and the like). In some embodiments, for each new drive plugged into or otherwise connected to a tray/drawer, the tray manager for that tray/drawer may be configured to automatically perform discovery of that drive.

The tray manager may inspect the drive and run one or more read and write operation tests in order to measure/collect one or more performance characteristics of the drive (e.g., how long the drive takes to perform specific test operations). For example, the tray manager may conduct one or more sequential IO tests, random IO tests, test blocks of the drive, IO test of various data sizes or types, and the like. As another example, the tray manager may measure latency associated with performance of the write ahead logs (WALs) of the drive in order to determine the overall latency characteristics of the drive. Examples of measured or collected performance data associated with a drive may include, without limitation, drive latency, the number of IO requests completed per second, average latency, median latency, 90th percentile latency, 95th percentile latency, and/or the like. These may be referred to as drive assisted or associated QoS. Tray manager may also determine the current actual capacity of the drive, which may differ from the nominal capacity value provided by the drive's manufacturer.

When the drive may be partitioned into two or more portions, each such partition may be similarly evaluated to determine partition latency and partition actual capacity characteristics.

In some embodiments, additional hardware state information associated with the drive may also be obtained by the tray manager. Examples of information discovered about a drive may include, without limitation, drive working status (e.g., working/up status, not working/down status, about to stop working, out for service, newly plugged in, etc.), time and date of inclusion in the tray/drawer, time and date of removal from the tray/drawer, tray/drawer identifier, tray/drawer location within the rack, tray/drawer's state information (e.g., power source, network, thermal, etc. conditions), drive's nominal capacity, drive type, drive model/serial/manufacturer information, number of partitions in the drive, protocols supported by the drive, and the like. In some embodiments, rack managers associated with racks for which the trays/drawers may be discovering drives may also be configured to obtain real-time, near real-time, or current information about such racks. Examples of information discovered for each rack in which a drive may undergo discovery may include, without limitation, rack identifier, rack's spatial location (e.g., within a data center, location coordinates, etc.), which data center rack may be located, rack state information (e.g., power source, network, thermal, etc. conditions), and the like.

Once performance characteristics of the drives and/or partitions of the drives have been obtained, pod manager(s) included in the rack scale module 123 may be configured to determine volume groups for the drives and/or partitions of the drives of the storage 140 based on the discovered drive information, at a block 408. A volume group may be defined for each volume created in block 404. In some embodiments, performance characteristics (e.g., latency) of respective drives (and/or partitions of drives) may be matched to performance characteristics (e.g., performance or latency bands or ranges) associated with respective volumes designated at block 404, so as to identify which drives (and/or partitions of drives) of the storage 140 may be grouped together as a volume group. If each volume may be considered to be a bucket, the operation of block 404 may identify and place particular drives (and/or partitions of drives) into the bucket. Since each volume group may be the grouping of certain drives for a respective volume of the plurality of volumes, both a volume and its corresponding volume group may be considered to have the same performance characteristics. And each volume group of the plurality of volume groups may have performance characteristics different from another volume group of the plurality of volume groups. Performance characteristics may also be referred to as performance band, performance range, latency band, latency range, latency, QoS, performance attributes, and the like. The grouping of drives (and/or partitions of drives) to form the plurality of volume groups facilitates enforcement and/or takes into account performance requirements of clients (e.g., client assisted or specified QoS) and actual performance characteristics of the drives (e.g., drive assisted QoS). Then use of the volume groups, as described in detail below, may comprise enforcement and/or taking into account performance characteristics of volume groups (e.g., volume group QoS).

Once the volume groups associated with different performance characteristics have been initially determined at block 408, which drives (and/or partitions of drives) may be grouped together into volume groups may be updated upon performance changes, such as when a drive's latency may change during normal operations. To that end, pod manager(s) may be configured to monitor for occurrence of changes at a block 410. In some embodiments, detection of changes may be pushed by tray and/or rack managers to the pod manager(s). Alternatively, a pull model may be implemented to obtain current change information.

When a change occurs (yes branch of block 410), process 400 may return to block 408 in order for the pod manager(s) to update the volume group(s) in accordance with the change. In some instances, a change to a particular drive (or partition of a drive) may cause the particular drive (or partition of a drive) to be reclassified in a volume group different from its previous volume group.

When no change has been detected (no branch of block 410), the determine volume groups of block 408 may be transmitted to the storage 140, and in particular QoS module 142 included in storage 140.

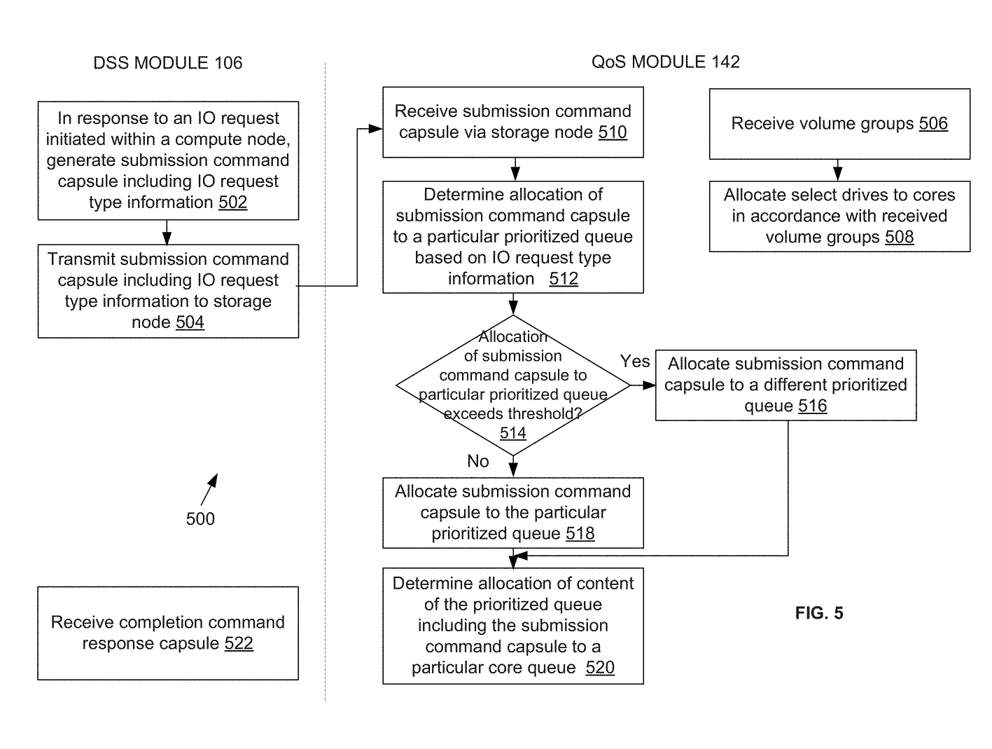

FIG. 5 depicts an example process 500 that may be performed by a DSS module (e.g., DSS module 106) and a QoS module (e.g., QoS module 142) to fulfill an IO request initiated by a compute node including the DSS module (e.g., compute node 104), according to some embodiments.

At a block 502, in response to an IO request initiated within the compute node 104, DSS module 106 may be configured to generate a submission command capsule (also referred to as an IO request command) including IO request type information associated with the IO request. In some embodiments, IO requests may be initiated by one or more applications running on the compute node 104. The IO requests initiated by applications may comprise read requests, write requests, foreground operations, and/or client (initiated) requests. Since the one or more applications may be executing to perform services for one or more clients, IO requests initiated by applications may also be referred to as client requests or operations. IO requests may also be initiated by the compute node 104, in which the IO requests or operations may comprise one or more background operations to be performed by the storage 140 to itself. Examples of background operations may include, without limitation, background scrubbing, drive rebuild, de-duping, tiering, maintenance, housekeeping, and the like functions to be performed on one or more drives of the storage 140. In some embodiments, at least some of the IO requests initiated within the compute node 104 may be transmitted to a storage node without being processed by DSS module 106.

In some embodiments, the submission command capsule generated may comprise a packet formatted in accordance with the NVMe-oF protocol. The packet may include, among other fields, a metadata pointer field and a plurality of data object payload fields (e.g., physical region page (PRP) entry 1, PRP entry 2). The metadata pointer field may include IO request type information (also referred to as metadata or IO request type metadata), such as an identifier or indication that the IO request comprises a foreground operation (also referred to as client operation) (e.g., IO requests from applications) or a background operation (e.g., IO requests that are not read or write requests from applications associated with clients). In some embodiments, the metadata pointer field may further include additional information about the IO request such as, but not limited to, identifier of the client associated with the IO request. The plurality of data object payload fields may include the data object associated with the IO request.

Next, at a block 504, DSS module 106 may be configured to transmit or facilitate transmission of the submission command capsule generated in block 502 to a particular storage node associated with the storage 140 (e.g., storage node 120) via network 102. And correspondingly, storage node 120 may be configured to issue the received submission command capsule to the storage 140 via network 102. Accordingly, storage 140, and in particular, QoS module 142 included in storage 140 may receive the submission command capsule that includes the IO request type information, at a block 510.

Simultaneous with or prior to block 510, QoS module 142 may be configured to receive volume groups information for the storage 140 from rack scale module 123, at a block 506. Volume groups may be those transmitted in block 412 of FIG. 4. QoS module 142, in response, may allocate/map or facilitate allocation/mapping of processor cores involved in drive submissions to drives (and/or partitions of drives) of the storage 140 in accordance with the received volume groups information, at a block 508. In some embodiments, the storage 140 may include a plurality of core queues, a core queue for each of the processor cores involved in drive submissions. The plurality of core queues may be logically disposed between the respective processor cores involved in drive submissions and respective volume groups of drives (or drive controllers associated with the drives). Because each volume group of the plurality of volume groups may be associated with particular performance characteristics, a core queue and its allocated/mapped volume group may both be deemed to be associated with the same performance characteristics.

Returning to block 512, in response to receipt of the submission command capsule in block 510, QoS module 142 may be configured to determine which prioritized queue of a plurality of prioritized queues to place the received submission command capsule. Storage 140 may include a plurality of prioritized queues, each prioritized queue of the plurality of prioritized queues having a priority level (also referred to as IO request handling priority level) different from another prioritized queue of the plurality of prioritized queues. The plurality of prioritized queues may comprise queues or queue constructs associated with a compute process side of submission fulfillment in the storage 140. Prioritized queues may also be referred to as priority queues. Determining or identifying which priority queue to place the received submission command capsule may also be considered to be assigning a particular priority level of a plurality of priority levels to the received submission command capsule.

In some embodiments, the QoS module 142 may be configured to identify a particular prioritized queue for the received submission command capsule using the IO request type information included in the received submission command capsule. Because different types of IO requests may have different handling requirements, e.g., not all IO requests require being fulfilled as soon as possible and/or as fast as possible, different types of IO requests may be differently prioritized from each other. For example, when the submission command capsule may be associated with a foreground operation or client operation, the submission command capsule may be matched to a prioritized queue having the highest priority level since foreground operations may be deemed to be of the highest priority for purposes of consistent QoS enforcement. As another example, when the submission command capsule may be associated with a background operation, the submission command capsule may be matched to a prioritized queue having a low, lowest, or near lowest priority level since background operations may be deemed to be of low or lowest priority relative to foreground operations for purposes of consistent QoS enforcement. As still another example, when the submission command capsule may lack IO request type information, such IO request may be matched or allocated to prioritized queue having the low, lowest, or near lowest priority level since the lack of IO request type information may be indicative of the capsule being a lower priority request, even if it is still a foreground operation request from a client.

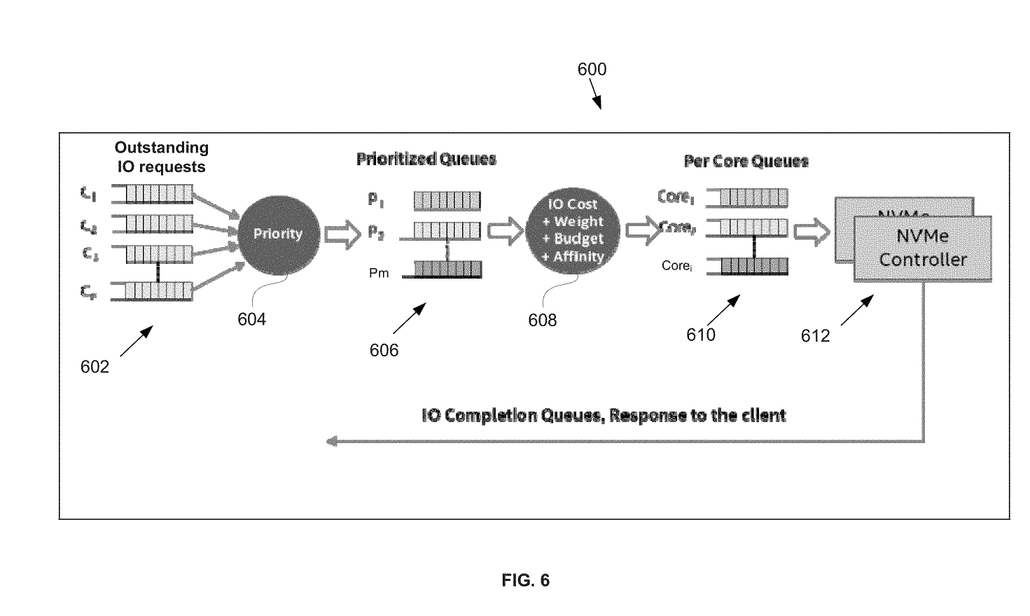

FIG. 6 depicts an example diagram 600 illustrating depictions of submission command capsules 602 and queues 606 and 610 which may be implemented to provide dynamic end to end QoS enforcement of the present disclosure, in some embodiments. The submission command capsules 602 may comprise a plurality of submission command capsules (also referred to as a plurality of IO request commands) originating from compute nodes 104, 114 received at the storage 140, which are to be processed or handled by the QoS module 142 in order to complete the respective IO requests. The submission command capsules 602 may also be referred to as outstanding IO requests. Each submission command capsule of the submission command capsules 602 may be designated as C₁, C₂, C₃, . . . , or Cₙ. Some of the submission command capsules 602 may comprise IO requests including IO request type information (e.g., foreground type IO requests, background type IO requests, client IO requests, IO requests associated with particular clients) and others of the submission command capsules 602 may comprise IO requests lacking IO request type information.

Prioritized queues 606 may comprise a plurality of prioritized queues P₁, P₂, P₃, . . . , Pₘ, in which P₁ may be the highest priority level queue, P₂ may be the next highest priority level queue, and so on to Pₘ being the lowest priority level queue. In some embodiments, the number m of prioritized queues 606 may be less than the number n of submission command capsules 602.

In some embodiments, allocation of the received submission command capsule to a particular prioritized queue may be based only not on the IO request type information but also one or more additional factors. At a block 514, QoS module 142 may be configured to take into account one or more factors in addition to the submission command capsule to finalize determination of a particular prioritized queue for the received submission command capsule. QoS module 142 may consider, among other things, one or more of whether the number of capsules already placed into the provisional particular prioritized queue associated with the same client as with the received submission command capsule may exceed a pre-defined threshold, whether the total number of capsules already placed in the provisional particular prioritized queue may exceed a pre-defined threshold, and the like. Factor(s) external to the submission command capsule may be considered so that, for example, the client associated with the received submission command capsule (to the extent that the capsule comprises a client request) does not consume too much of the highest or high priority level queues to the detriment of the other clients' IO requests to the storage 140. Having too many capsules in a given prioritized queue may also create latencies which may be proactively prevented to the extent possible. The QoS requirements of the submission command capsule as well as the larger or overall workload requirements in the storage 140 may be considered. Thus, QoS requirements of a plurality of clients, and not just the client associated with the received submission command capsule, may be enforced.

When the relevant threshold(s) may be deemed to be exceeded (yes branch of block 514), then QoS module 142 may be configured to allocate the received submission command capsule to a different prioritized queue from the one provisionally selected in block 512, at a block 516. The different prioritized queue may comprise the next lower priority level prioritized queue from the provisionally selected priority queue, or the next lower priority level prioritized queue that does not exceed the thresholds. Then process 500 may proceed to block 520. When the relevant threshold(s) may be deemed not to be exceeded (no branch of block 514), then QoS module 142 may be configured to allocate the received submission command capsule to the particular prioritized queue provisionally selected in block 512, at a block 518.

Next at a block 520, in order to move at least some of the IO requests queued in the prioritized queues (and in particular, the received submission command capsule) to select core queue(s) of the plurality of core queues, QoS module 142 may be configured to determine which core queue(s) to receive the queued content. The plurality of core queues may comprise queues or queue constructs associated with a drive submission process side of submission fulfillment in the storage 140. In some embodiments, selection of the core queue to receive the received submission command capsule from a priority queue may be based on affinity of the priority level associated with the priority queue in which the received submission command capsule may be located to performance characteristics associated with a core queue (also referred to as core affinity) and one or more factors such as, but not limited to, current load in the core queue of interest, current load or latency of the drive(s) of interest, weights assigned to priority queues, IO cost, and the like.

As discussed above with respect to block 508, each processor core associated with submission handling may be allocated with drives (and/or partitions of drives) of a volume group having a particular performance characteristic. The highest priority level priority queue may have an affinity with the core queue/processor core/drives associated with a volume group having the lowest latency. Similar affinity pairs may be constructed between successive priority levels and latencies for the remaining priority queues and core queues/processor cores/drives. Although the priority level of a particular core queue of the plurality of core queues may have an affinity with the priority queue in which the received submission command capsule may be queued, QoS module 142 may implement flexibility or dynamism in the matching in accordance with the current state of the core queues and/or drives associated with the core queues. For example, if a core queue provisionally matched to the prioritized queue that includes the received submission command capsule may currently have a larger than usual queue load (e.g., queue load exceeds a threshold), or one or more drives (or partitions of drives) designated to the core queue may be busier than usual (e.g., number of operations to be performed exceeds a threshold), then some or all of the content of the prioritized queue including the received submission command capsule may be allocated to one or more other core queues (e.g., other core queue(s) which may currently have a lower workload).

Each of the prioritized queue of the plurality of prioritized queues may be assigned a weight, the higher the priority level the greater the weight. Alternatively, the plurality of prioritized queues may be assigned a probabilistic distribution. In some embodiments, each prioritized queue may get a certain number of sectors of queued content which may be transferred out per transfer cycle, with an IO cost normalized to the number of sectors. For example, if an IO request is not a read or write request (e.g., a trim operation), then the IO cost may be considered to be zero. Transfer out from respective prioritized queues of the plurality of prioritized queues may occur in round robin fashion to avoid starvation by any of the prioritized queues.

Returning to FIG. 6, operation 604 may be similar to the determination performed by the QoS module 142 in blocks 512-518 to determine which prioritized queue for each of the C₁ to Cₙ submission command capsules 602.

As an example, the submission command capsule received in block 510 may be designated C₁. If submission command capsule C₁ includes IO request type information indicative of a foregoing operation, then submission command capsule C₁ may be allocated (at least provisionally) to prioritized queue P₁, which may be for the highest priority level IO request handling. Highest priority level handling may comprise the quickest handling time and thus, the lowest latency or highest QoS possible by the storage 140.

Operation 608 may be similar to the determination performed by the QoS module 142 in block 520. A plurality of core queues 610 is shown, Core₁, Core₂, Core₃, . . . , Coreᵢ, in which the number of cores i may be the same or different from the number of prioritized queues 606. The content (or at least the submission command capsule C₁) of prioritized queue P₁ may be placed into core queue Core₁ if thresholds associated with Core₁ and drives accessible via Core₁ may not be exceeded. Otherwise, the next core queue Core₂ may be selected.

Submission command capsules included in the core queues may be acted on by respective drive controllers (e.g., NVMe controllers 612) to perform the requested IO operations on the drives (and/or partitions of drives) of the storage 140. Upon completion of IO operations specified in the submission command capsules, respective completion command response capsules (also referred to as IO request completion response, completion response, or response) may be generated by the storage 140 to be provided to the originating compute node(s) via storage node(s) and the network 102.

Returning to FIG. 5, DSS module 106 may be configured to receive a completion command response capsule from the storage 140, at a block 522, upon completion/fulfillment by the storage 140 of the submission command capsule transmitted in block 504.

In some embodiments, one or more of blocks 402, 404 may be performed and/or information obtained from performance of blocks 402, 404 may be used during fulfillment of an IO request. For example, the client-specific performance requirements of block 402 (along with the other factors discussed above) may be used by the QoS module 142 to identify a particular volume group of drives having QoS attributes that match (or best match) the QoS requirements of the IO request. Alternatively, blocks 402 and/or 404 may be optional during a discovery phase of the drives, and blocks 402 and/or 404 may be implemented after an IO request has issued from a compute node in connection with fulfillment of the current IO request.

In this manner, end to end QoS enforcement (e.g., latency) may be achieved in the fulfillment of IO requests originating within compute nodes, in which such end to end QoS enforcement may be implemented in a flexible, dynamic, and multi-factor manner. Client assisted, specified, and/or related QoS; volume group QoS associated with particular grouping of drives and/or partitions of drives of storage; and drive assisted, specified, and/or related QoS associated with current performance attributes of drives and/or partitions of drives of storage may be used to optimize resources of the storage in fulfillment of IO requests.

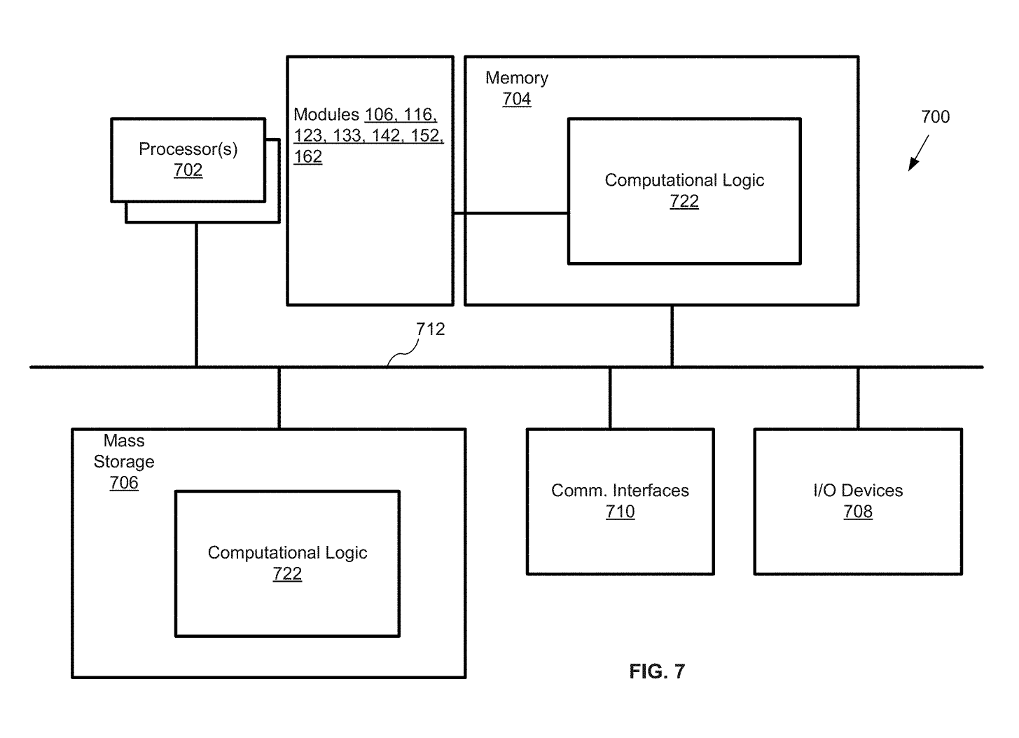

FIG. 7 illustrates an example computer device 700 suitable for use to practice aspects of the present disclosure, in accordance with various embodiments. In some embodiments, computer device 700 may comprise at least a portion of any of the compute node 104, compute node 114, storage node 120, storage node 130, storage 140, storage 150, storage 160, rack 200, rack 210, and/or rack 220. As shown, computer device 700 may include one or more processors 702, and system memory 704. The processor 702 may include any type of processors. The processor 702 may be implemented as an integrated circuit having a single core or multi-cores, e.g., a multi-core microprocessor. The computer device 700 may include mass storage devices 706 (such as diskette, hard drive, volatile memory (e.g., DRAM), compact disc read only memory (CD-ROM), digital versatile disk (DVD), flash memory, solid state memory, and so forth). In general, system memory 704 and/or mass storage devices 706 may be temporal and/or persistent storage of any type, including, but not limited to, volatile and non-volatile memory, optical, magnetic, and/or solid state mass storage, and so forth. Volatile memory may include, but not be limited to, static and/or dynamic random access memory. Non-volatile memory may include, but not be limited to, electrically erasable programmable read only memory, phase change memory, resistive memory, and so forth.

The computer device 700 may further include input/output (I/O or IO) devices 708 such as a microphone, sensors, display, keyboard, cursor control, remote control, gaming controller, image capture device, and so forth and communication interfaces 710 (such as network interface cards, modems, infrared receivers, radio receivers (e.g., Bluetooth)), antennas, and so forth.

The communication interfaces 710 may include communication chips (not shown) that may be configured to operate the device 700 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chips may also be configured to operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may be configured to operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 710 may operate in accordance with other wireless protocols in other embodiments.

The above-described computer device 700 elements may be coupled to each other via a system bus 712, which may represent one or more buses. In the case of multiple buses, they may be bridged by one or more bus bridges (not shown). Each of these elements may perform its conventional functions known in the art. In particular, system memory 704 and mass storage devices 706 may be employed to store a working copy and a permanent copy of the programming instructions implementing the operations associated with system 100, e.g., operations associated with providing one or more of modules 106, 116, 123, 133, 142, 152, 162 as described above, generally shown as computational logic 722. Computational logic 722 may be implemented by assembler instructions supported by processor(s) 702 or high-level languages that may be compiled into such instructions. The permanent copy of the programming instructions may be placed into mass storage devices 706 in the factory, or in the field, through, for example, a distribution medium (not shown), such as a compact disc (CD), or through communication interfaces 710 (from a distribution server (not shown)).

In some embodiments, one or more of modules 106, 116, 123, 133, 142, 152, 162 may be implemented in hardware integrated with, e.g., communication interface 710. In other embodiments, one or more of modules 106, 116, 123, 133, 142, 152, 162 (or some functions of modules 106, 116, 123, 133, 142, 152, 162) may be implemented in a hardware accelerator integrated with, e.g., processor 702, to accompany the central processing units (CPU) of processor 702.

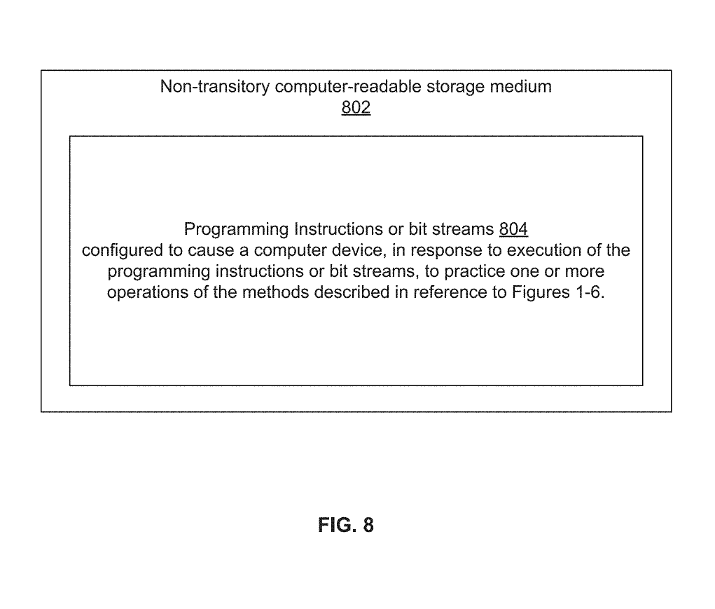

FIG. 8 illustrates an example non-transitory computer-readable storage media 802 having instructions configured to practice all or selected ones of the operations associated with the processes described above. As illustrated, non-transitory computer-readable storage medium 802 may include a number of programming instructions 804 configured to implement one or more of modules 106, 116, 123, 133, 142, 152, 162, or bit streams 804 to configure the hardware accelerators to implement some of the functions of modules 106, 116, 123, 133, 142, 152, 162. Programming instructions 804 may be configured to enable a device, e.g., computer device 700, in response to execution of the programming instructions, to perform one or more operations of the processes described in reference to FIGS. 1-6. In alternate embodiments, programming instructions/bit streams 804 may be disposed on multiple non-transitory computer-readable storage media 802 instead. In still other embodiments, programming instructions/bit streams 804 may be encoded in transitory computer-readable signals.

Referring again to FIG. 7, the number, capability, and/or capacity of the elements 708, 710, 712 may vary, depending on whether computer device 700 is used as a stationary computing device, such as a set-top box or desktop computer, or a mobile computing device, such as a tablet computing device, laptop computer, game console, an Internet of Things (IoT), or smartphone. Their constitutions are otherwise known, and accordingly will not be further described.

At least one of processors 702 may be packaged together with memory having computational logic 722 (or portion thereof) configured to practice aspects of embodiments described in reference to FIGS. 1-6. For example, computational logic 722 may be configured to include or access one or more of modules 106, 116, 123, 133, 142, 152, 162. In some embodiments, at least one of the processors 702 (or portion thereof) may be packaged together with memory having computational logic 722 configured to practice aspects of processes 300, 400 to form a System in Package (SiP) or a System on Chip (SoC).

In various implementations, the computer device 700 may comprise a desktop computer, a server, a router, a switch, or a gateway. In further implementations, the computer device 700 may be any other electronic device that processes data.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein.

Examples of the devices, systems, and/or methods of various embodiments are provided below. An embodiment of the devices, systems, and/or methods may include any one or more, and any combination of, the examples described below.

Example 1 is an apparatus including one or more storage devices; and one or more processors including a plurality of processor cores in communication with the one or more storage devices, wherein the one or more processors include a module that is to allocate an input/output (IO) request command, associated with an IO request originated within a compute node, to a particular first queue of a plurality of first queues based at in part on IO request type information included in the IO request command, the compute node and the apparatus distributed over a network and the plurality of first queues associated with different submission handling priority levels among each other, and wherein the module allocates the IO request command queued within the particular first queue to a particular second queue of a plurality of second queues based at least in part on affinity of a first submission handling priority level associated with the particular first queue to current quality of service (QoS) attributes of a subset of the one or more storage devices associated with the particular second queue.

Example 2 may include the subject matter of Example 1, and may further include wherein the module is to allocate the IO request command to the particular first queue based on the IO request type information included in the IO request command and one or more of a number of existing IO request commands in the particular first queue associated with a same client as the IO request command to be allocated and a total number of IO request commands in the particular first queue.

Example 3 may include the subject matter of any of Examples 1-2, and may further include wherein the module is to allocate the IO request command to the particular second queue based on the affinity of the first submission handling priority level associated with the particular first queue to the current QoS attributes of the subset of the one or more storage devices associated with the particular second queue and one or more of a current load of the particular second queue, a current load or latency of the subset of the one or more storage devices associated with the particular second queue, weights assigned to the plurality of first queues, and IO cost for IO request type.

Example 4 may include the subject matter of any of Examples 1-3, and may further include wherein the plurality of second queues comprises a plurality of core queues associated with respective plurality of processor cores, the plurality of core queues is disposed between the plurality of first queues and the one or more storage devices, and the subset of the one or more storage devices is defined as a volume group of a plurality of volume groups based on the current QoS attributes of the subset of the one or more storage devices matching a performance characteristic defined for a volume of the volume group.

Example 5 may include the subject matter of any of Examples 1-4, and may further include wherein the performance characteristic that defines the volume is defined by a plurality of clients to initiate IO requests to be handled by the apparatus.

Example 6 may include the subject matter of any of Examples 1-5, and may further include wherein the one or more processors receive the plurality of volume groups determined by another module included in the one or more racks that house the one or more storage devices, and the another module to automatically discover the current QoS attributes.

Example 7 may include the subject matter of any of Examples 1-6, and may further include wherein the IO request type information included in the IO request command is provided by the compute node prior to transmission of the IO request command from the compute node to a storage node distributed over the network and retransmission of the IO request command including the IO request type information from the storage node to the apparatus over the network.

Example 8 may include the subject matter of any of Examples 1-7, and may further include wherein the IO request type information comprises one or more of identification of a foreground operation, a background operation, an operation initiated by the compute node for the apparatus to perform drive maintenance, a client associated or initiated request, and a client identifier.

Example 9 may include the subject matter of any of Examples 1-8, and may further include wherein the one or more storage devices comprise solid state drives (SSDs), non-volatile memory (NVM), non-volatile dual in-line memory (DIMM), flash-based storage, or hybrid drives.

Example 10 may include the subject matter of any of Examples 1-9, and may further include wherein the IO request command comprises a submission command capsule and the IO request type information is included in a metadata pointer field of the submission command capsule.

Example 11 may include the subject matter of any of Examples 1-10, and may further include wherein the IO request comprises a read or write request made by an application executing on the compute node on behalf of a client user, or a background operation initiated by the compute node to be performed on the one or more storage devices associated with drive maintenance.

Example 12 may include the subject matter of any of Examples 1-11, and may further include wherein the current QoS attributes comprises one or more latencies associated with fulfillment of IO requests by the subset of the one or more storage devices.

Example 13 is a computerized method including, in response to receipt, over a network, of an input/output (IO) request command associated with an IO request that originates at a compute node of a plurality of compute nodes distributed over the network, determining allocation of the IO request command to a particular first queue of a plurality of first queues based at in part on IO request type information included in the IO request command, wherein the plurality of first queues associated with respective submission handling priority levels; and determining allocation of the IO request command queued within the particular first queue to a particular second queue of a plurality of second queues based at least in part on affinity of a first submission handling priority level associated with the particular first queue to current quality of service (QoS) attributes of a group of one or more storage devices associated with the particular second queue, wherein the plurality of second queues is disposed between the plurality of first queues and the group of one or more storage devices.

Example 14 may include the subject matter of Example 13, and may further include wherein determining allocation of the IO request command to the particular first queue comprises determining allocation of the IO request command based on the IO request type information included in the IO request command and one or more of a number of existing TO request commands in the particular first queue associated with a same client as the IO request command to be allocated and a total number of IO request commands in the particular first queue.

Example 15 may include the subject matter of any of Examples 13-14, and may further include wherein determining allocation of the IO request command to the particular second queue comprises determining allocation of the IO request command from the particular first queue to the particular second queue based on the affinity of the first submission handling priority level associated with the particular first queue to the current QoS attributes of the subset of the one or more storage devices associated with the particular second queue and one or more of a current load of the particular second queue, a current load or latency of the subset of the one or more storage devices associated with the particular second queue, weights assigned to the plurality of first queues, and TO cost for IO request type.

Example 16 may include the subject matter of any of Examples 13-15, and may further include receiving, from a storage node of a plurality of storage nodes distributed over the network, the IO request command, wherein the IO request type information included in the TO request command is provided by the compute node prior to transmission of the IO request command from the compute node to the storage node over the network and retransmission of the IO request command including the IO request type information from the storage node.

Example 17 may include the subject matter of any of Examples 13-16, and may further include wherein the IO request type information comprises one or more of identification of a foreground operation, a background operation, an operation initiated by the compute node for the apparatus to perform drive maintenance, a client associated or initiated request, and a client identifier.

Example 18 may include the subject matter of any of Examples 13-17, and may further include wherein the IO request command comprises a submission command capsule, and wherein the IO request type information is included in a metadata pointer field of the submission command capsule.

Example 19 may include the subject matter of any of Examples 13-18, and may further include wherein the IO request comprises a read or write request made by an application executing on the compute node on behalf of a client user, or a background operation initiated by the compute node to be performed on the one or more storage devices associated with drive maintenance.

Example 20 is an apparatus including a plurality of compute nodes distributed over a network, a compute node of the plurality of compute nodes to issue an input/output (IO) request command associated with an IO request, the IO request command to include an IO request type identifier; and a plurality of storage distributed over the network and in communication with the plurality of compute nodes, wherein a storage includes a module that is to assign a particular priority level to the IO request command received over the network and determine placement of the IO request command to a particular core queue of a plurality of core queues, the plurality of core queues associated with respective select group of storage devices included in the storage in accordance with IO request type identifier extracted from the IO request command and an affinity of particular priority level to current quality of service (QoS) attributes of a select group of storage devices associated with the particular core queue.

Example 21 may include the subject matter of Example 20, and may further include wherein the IO request type identifier comprises one or more of identification of a foreground operation, a background operation, an operation initiated by the compute node for the apparatus to perform drive maintenance, a client associated or initiated request, and a client identifier.

Example 22 may include the subject matter of any of Examples 20-21, and may further include wherein the IO request type identifier is included in a metadata pointer field of the IO request command, and wherein the select group of storage devices comprises solid state drives (SSDs), non-volatile memory (NVM), non-volatile dual in-line memory (DIMM), flash-based storage, or hybrid drives.

Example 23 may include the subject matter of any of Examples 20-22, and may further include a plurality of storage nodes distributed over the network and in communication with the plurality of compute nodes and the plurality of storage, the plurality of storage nodes associated with respective one or more of storage of the plurality of storage, and wherein a storage node of the plurality of storage node to receive the IO request command from the compute node of the plurality of compute nodes over the network and to transmit the IO request command to particular one or more of the associated storage.

Example 24 is an apparatus including, in response to receipt, over a network, of an input/output (IO) request command associated with an IO request that originates at a compute node of a plurality of compute nodes distributed over the network, means for determining allocation of the IO request command to a particular first queue of a plurality of first queues based at in part on IO request type information included in the IO request command, wherein the plurality of first queues associated with respective submission handling priority levels; and means for determining allocation of the IO request command queued within the particular first queue to a particular second queue of a plurality of second queues based at least in part on affinity of a first submission handling priority level associated with the particular first queue to current quality of service (QoS) attributes of a group of one or more storage devices associated with the particular second queue, wherein the plurality of second queues is disposed between the plurality of first queues and the group of one or more storage devices.

Example 25 may include the subject matter of Example 24, and may further include wherein the means for determining allocation of the IO request command to the particular first queue comprises means for determining allocation of the IO request command based on the IO request type information included in the IO request command and one or more of a number of existing IO request commands in the particular first queue associated with a same client as the IO request command to be allocated and a total number of IO request commands in the particular first queue.

Example 26 may include the subject matter of any of Examples 24-25, and may further include wherein the means for determining allocation of the IO request command to the particular second queue comprises means for determining allocation of the IO request command from the particular first queue to the particular second queue based on the affinity of the first submission handling priority level associated with the particular first queue to the current QoS attributes of the subset of the one or more storage devices associated with the particular second queue and one or more of a current load of the particular second queue, a current load or latency of the subset of the one or more storage devices associated with the particular second queue, weights assigned to the plurality of first queues, and TO cost for IO request type.

Example 27 may include the subject matter of any of Examples 24-26, and may further include means for receiving, from a storage node of a plurality of storage nodes distributed over the network, the IO request command, wherein the IO request type information included in the IO request command is provided by the compute node prior to transmission of the IO request command from the compute node to the storage node over the network and retransmission of the IO request command including the IO request type information from the storage node.

Example 28 may include the subject matter of any of Examples 24-27, and may further include wherein the IO request type information comprises one or more of identification of a foreground operation, a background operation, an operation initiated by the compute node for the apparatus to perform drive maintenance, a client associated or initiated request, and a client identifier.

Example 29 may include the subject matter of any of Examples 24-28, and may further include wherein the IO request command comprises a submission command capsule, and wherein the IO request type information is included in a metadata pointer field of the submission command capsule.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

We claim:

1. An apparatus comprising:
one or more storage devices; and
one or more processors including a plurality of processor cores in communication with the one or more storage devices, wherein the one or more processors include a module that is to allocate an input/output (IO) request command, associated with an IO request originated within a compute node, to a particular first queue of a plurality of first queues based at in part on IO request type information included in the IO request command, the compute node and the apparatus distributed over a network and the plurality of first queues associated with different submission handling priority levels among each other, and wherein the module allocates the IO request command queued within the particular first queue to a particular second queue of a plurality of second queues based at least in part on affinity of a first submission handling priority level associated with the particular first queue to current quality of service (QoS) attributes of a subset of the one or more storage devices associated with the particular second queue.

2. The apparatus of claim 1, wherein the module is to allocate the IO request command to the particular first queue based on the IO request type information included in the IO request command and one or more of a number of existing IO request commands in the particular first queue associated with a same client as the IO request command to be allocated and a total number of IO request commands in the particular first queue.

3. The apparatus of claim 1, wherein the module is to allocate the IO request command to the particular second queue based on the affinity of the first submission handling priority level associated with the particular first queue to the current QoS attributes of the subset of the one or more storage devices associated with the particular second queue and one or more of a current load of the particular second queue, a current load or latency of the subset of the one or more storage devices associated with the particular second queue, weights assigned to the plurality of first queues, and IO cost for IO request type.

4. The apparatus of claim 1, wherein the plurality of second queues comprises a plurality of core queues associated with respective plurality of processor cores, the plurality of core queues is disposed between the plurality of first queues and the one or more storage devices, and the subset of the one or more storage devices is defined as a volume group of a plurality of volume groups based on the current QoS attributes of the subset of the one or more storage devices matching a performance characteristic defined for a volume of the volume group.

5. The apparatus of claim 4, wherein the performance characteristic that defines the volume is defined by a plurality of clients to initiate IO requests to be handled by the apparatus.

6. The apparatus of claim 4, wherein the one or more processors receive the plurality of volume groups determined by another module included in the one or more racks that house the one or more storage devices, and the another module to automatically discover the current QoS attributes.

7. The apparatus of claim 1, wherein the IO request type information included in the IO request command is provided by the compute node prior to transmission of the IO request command from the compute node to a storage node distributed over the network and retransmission of the IO request command including the IO request type information from the storage node to the apparatus over the network.

8. The apparatus of claim 1, wherein the IO request type information comprises one or more of identification of a foreground operation, a background operation, an operation initiated by the compute node for the apparatus to perform drive maintenance, a client associated or initiated request, and a client identifier.

9. The apparatus of claim 1, wherein the one or more storage devices comprise solid state drives (SSDs), non-volatile memory (NVM), non-volatile dual in-line memory (DIMM), flash-based storage, or hybrid drives.

10. The apparatus of claim 9, wherein the IO request command comprises a submission command capsule and the IO request type information is included in a metadata pointer field of the submission command capsule.

11. The apparatus of claim 1, wherein the IO request comprises a read or write request made by an application executing on the compute node on behalf of a client user, or a background operation initiated by the compute node to be performed on the one or more storage devices associated with drive maintenance.

12. A computerized method comprising:
in response to receipt, over a network, of an input/output (IO) request command associated with an IO request that originates at a compute node of a plurality of compute nodes distributed over the network, determining allocation of the IO request command to a particular first queue of a plurality of first queues based at in part on IO request type information included in the IO request command, wherein the plurality of first queues associated with respective submission handling priority levels; and
determining allocation of the IO request command queued within the particular first queue to a particular second queue of a plurality of second queues based at least in part on affinity of a first submission handling priority level associated with the particular first queue to current quality of service (QoS) attributes of a group of one or more storage devices associated with the particular second queue, wherein the plurality of second queues is disposed between the plurality of first queues and the group of one or more storage devices.

13. The method of claim 12, wherein determining allocation of the IO request command to the particular first queue comprises determining allocation of the IO request command based on the IO request type information included in the IO request command and one or more of a number of existing IO request commands in the particular first queue associated with a same client as the IO request command to be allocated and a total number of IO request commands in the particular first queue.

14. The method of claim 12, wherein determining allocation of the IO request command to the particular second queue comprises determining allocation of the IO request command from the particular first queue to the particular second queue based on the affinity of the first submission handling priority level associated with the particular first queue to the current QoS attributes of the subset of the one or more storage devices associated with the particular second queue and one or more of a current load of the particular second queue, a current load or latency of the subset of the one or more storage devices associated with the particular second queue, weights assigned to the plurality of first queues, and IO cost for IO request type.

15. The method of claim 12, further comprising receiving, from a storage node of a plurality of storage nodes distributed over the network, the IO request command, wherein the IO request type information included in the IO request command is provided by the compute node prior to transmission of the IO request command from the compute node to the storage node over the network and retransmission of the IO request command including the IO request type information from the storage node.

16. The method of claim 12, wherein the IO request type information comprises one or more of identification of a foreground operation, a background operation, an operation initiated by the compute node for the apparatus to perform drive maintenance, a client associated or initiated request, and a client identifier.

17. The method of claim 12, wherein the IO request command comprises a submission command capsule, and wherein the IO request type information is included in a metadata pointer field of the submission command capsule.

18. An apparatus comprising:
a plurality of compute nodes distributed over a network, a compute node of the plurality of compute nodes to issue an input/output (IO) request command associated with an IO request, the IO request command to include an IO request type identifier; and
a plurality of storage distributed over the network and in communication with the plurality of compute nodes, wherein a storage includes a module that is to assign a particular priority level to the IO request command received over the network and determine placement of the IO request command to a particular core queue of a plurality of core queues, the plurality of core queues associated with respective select group of storage devices included in the storage in accordance with IO request type identifier extracted from the IO request command and an affinity of particular priority level to current quality of service (QoS) attributes of a select group of storage devices associated with the particular core queue.

19. The apparatus of claim 18, wherein the IO request type identifier comprises one or more of identification of a foreground operation, a background operation, an operation initiated by the compute node for the apparatus to perform drive maintenance, a client associated or initiated request, and a client identifier.

20. The apparatus of claim 18, wherein the IO request type identifier is included in a metadata pointer field of the IO request command, and wherein the select group of storage devices comprises solid state drives (SSDs), non-volatile memory (NVM), non-volatile dual in-line memory (DIMM), flash-based storage, or hybrid drives.

21. The apparatus of claim 18, further comprising a plurality of storage nodes distributed over the network and in communication with the plurality of compute nodes and the plurality of storage, the plurality of storage nodes associated with respective one or more of storage of the plurality of storage, and wherein a storage node of the plurality of storage node to receive the IO request command from the compute node of the plurality of compute nodes over the network and to transmit the IO request command to particular one or more of the associated storage.

22. An apparatus comprising:
in response to receipt, over a network, of an input/output (IO) request command associated with an IO request that originates at a compute node of a plurality of compute nodes distributed over the network, means for determining allocation of the IO request command to a particular first queue of a plurality of first queues based at in part on IO request type information included in the IO request command, wherein the plurality of first queues associated with respective submission handling priority levels; and
means for determining allocation of the IO request command queued within the particular first queue to a particular second queue of a plurality of second queues based at least in part on affinity of a first submission handling priority level associated with the particular first queue to current quality of service (QoS) attributes of a group of one or more storage devices associated with the particular second queue, wherein the plurality of second queues is disposed between the plurality of first queues and the group of one or more storage devices.

23. The apparatus of claim 22, wherein the means for determining allocation of the TO request command to the particular first queue comprises means for determining allocation of the IO request command based on the IO request type information included in the IO request command and one or more of a number of existing IO request commands in the particular first queue associated with a same client as the IO request command to be allocated and a total number of IO request commands in the particular first queue.

24. The apparatus of claim 22, further comprising means for receiving, from a storage node of a plurality of storage nodes distributed over the network, the IO request command, wherein the IO request type information included in the IO request command is provided by the compute node prior to transmission of the IO request command from the compute node to the storage node over the network and retransmission of the IO request command including the TO request type information from the storage node.

25. The apparatus of claim 22, wherein the IO request type information comprises one or more of identification of a foreground operation, a background operation, an operation initiated by the compute node for the apparatus to perform drive maintenance, a client associated or initiated request, and a client identifier.

26. The apparatus of claim 22, wherein the IO request command comprises a submission command capsule, and wherein the IO request type information is included in a metadata pointer field of the submission command capsule.
